(19) United States
(12) Patent Application Publication
(10) Pub. No.: US 2024/0052095 A1
(43) Pub. Date: Feb. 15, 2024

(54) MANUFACTURING METHOD OF THERMOPLASTIC POLYESTER ELASTOMER

(71) Applicant: NAN YA PLASTICS CORPORATION, Taipei (TW)

(72) Inventors: Te-Chao Liao, TAIPEI (TW); Ching-Yao Yuan, TAIPEI (TW); Wei Tang Liao, TAIPEI (TW)

(73) Assignee: NAN YA PLASTICS CORPORATION, TAIPEI (TW)

(21) Appl. No.: 17/978,978

(22) Filed: Nov. 2, 2022

(30) Foreign Application Priority Data
Aug. 12, 2022 (TW) 111130472

(51) Int. Cl. C08G 63/672; C08G 63/183; C08G 63/85; C08L 67/02

(52) U.S. Cl. CPC C08G 63/672; C08G 63/183; C08G 63/85; C08L 67/025; C08L 2207/04; C08L 2207/20; C08L 2308/00

(57) ABSTRACT

A manufacturing method of a thermoplastic polyester elastomer at least includes the following. An alcoholysis reaction is performed by using recycled polyethylene terephthalate with aliphatic diols to form an intermediate product. The intermediate product is bis 2-hydroxyethyl terephthalate. The intermediate product is used for a polymerization reaction with long chain polyalkyl glycols to form the thermoplastic polyester elastomer.

### CROSS-REFERENCE TO RELATED APPLICATION

This application claims the priority benefit of Taiwan application serial no. 111130472, filed on Aug. 12, 2022. The entirety of the above-mentioned patent application is hereby incorporated by reference herein and made a part of this specification.

### BACKGROUND

### Technical Field

The disclosure relates to a manufacturing method of a polyester, and particularly relates to a manufacturing method of a thermoplastic polyester elastomer.

### Description of Related Art

Most of the existing moisture-permeable waterproof membranes use a thermoplastic polyester elastomer (TPEE) as the main material. However, the existing methods of manufacturing a thermoplastic polyester elastomer often involve a transesterification (esterification reaction), which can be easily accompanied by producing tetrahydrofuran (THF), a toxic and dangerous by-product. Therefore, the existing methods of manufacturing a thermoplastic polyester elastomer are problematic in not being environmentally friendly.

### SUMMARY

The disclosure provides a manufacturing method of a thermoplastic polyester elastomer, which effectively achieves environmental protection.

The manufacturing method of the thermoplastic polyester elastomer according to the disclosure at least includes the following. An alcoholysis reaction is performed by using recycled polyethylene terephthalate with aliphatic diols to form an intermediate product. The intermediate product is bis 2-hydroxyethyl terephthalate. The intermediate product is used for a polymerization reaction with long chain polyalkyl glycols to form the thermoplastic polyester elastomer.

In an embodiment of the disclosure, in the alcoholysis reaction, a ratio of the recycled polyethylene terephthalate to the aliphatic diols is 1:0.5 to 1:3.

In an embodiment of the disclosure, a ratio of the intermediate product in the thermoplastic polyester elastomer is 40 wt % to 80 wt %.

In an embodiment of the disclosure, a ratio of the long chain polyalkyl glycols in the thermoplastic polyester elastomer is 20 wt % to 60 wt %.

In an embodiment of the disclosure, the aliphatic diols include ethylene glycols, 1,3-propanediols, 1,4-butanediols, or a combination thereof.

In an embodiment of the disclosure, the long chain polyalkyl glycols include polyethylene glycols.

In an embodiment of the disclosure, an antioxidant is used in both the alcoholysis reaction and the polymerization reaction.

In an embodiment of the disclosure, an amount of addition of the antioxidant is 100 ppm to 5000 ppm.

In an embodiment of the disclosure, an alcoholysis catalyst is used in the alcoholysis reaction, and the alcoholysis catalyst includes a titanium compound, a tin compound, an antimony compound, or a combination thereof.

In an embodiment of the disclosure, a polymerization catalyst is used in the polymerization reaction, and the polymerization catalyst includes a titanium compound, a magnesium compound, a sodium compound, a phosphorus compound, a tin compound, an antimony compound, or a combination thereof.

Based on the above, the polyester raw material used in the manufacturing method of the thermoplastic polyester elastomer according to the disclosure comes from recycled polyethylene terephthalate, so that polyethylene terephthalate is recycled and used repeatedly to reduce the environmental problems caused by PET waste materials, and the use of bis 2-hydroxyethyl terephthalate (BHET) as a hard segment has higher heat resistance. In addition, since no transesterification reaction is performed after the formation of the intermediate product (bis 2-hydroxyethyl terephthalate), the by-product, THF, is not easily produced, and one manufacturing process is omitted. Thereby, energy consumption and carbon emission can be reduced, so environmental protection can be effectively achieved.

In order to make the above and other features and advantages of the disclosure more evident and easier to understand, the following embodiments are provided and represented in detail with the accompanying drawings as follows.

### BRIEF DESCRIPTION OF THE DRAWINGS

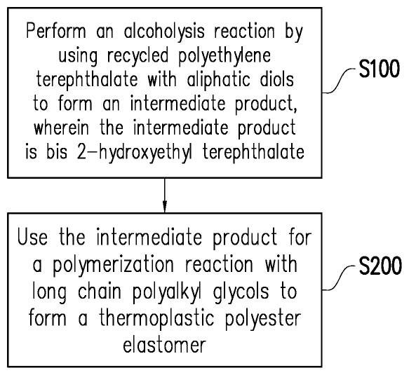

The FIG. 1s a schematic flowchart of a manufacturing method of a thermoplastic polyester elastomer according to an embodiment of the disclosure.

### DETAILED DESCRIPTION OF DISCLOSED EMBODIMENTS

In the following detailed description, for purposes of explanation and not limitation, exemplary embodiments disclosing specific details are set forth to provide a thorough understanding of various principles of the disclosure. However, it should be apparent to people with ordinary skills in the art that the disclosure may be practiced in other embodiments that depart from the specific details disclosed herein. Furthermore, descriptions of well-known devices, methods, and materials may be omitted so as not to obscure the description of various principles of the disclosure.

A range can be described herein as from “about” one specific value to “about” another specific value, and can also be directly described as one specific value and/or to another specific value. When expressing the range, another embodiment includes one specific value and/or to another specific value. Similarly, it should be understood that when an antecedent “about” is used to express an approximate value, the specific value establishes another embodiment. Further, it should be understood that an endpoint of each range is manifestly related or unrelated to the other endpoint.

In this disclosure, non-limiting terms (for example, may, can, for example, or other similar terms) mean unnecessary or optional implementations, inclusions, additions, or existence.

Unless otherwise defined, all terms (including technical and scientific terms) used herein have the same meanings as commonly understood by people with ordinary skills in the art.

Further, it should be understood that technical terms (such as those defined in commonly used dictionaries) should be interpreted consistently in the related technical context and should not be interpreted in an idealized or an overly formal sense, unless the terms are clearly defined as such.

The FIG. 1s a schematic flowchart of a manufacturing method of a thermoplastic polyester elastomer according to an embodiment of the disclosure. Please refer to the FIGURE. In step S100, an alcoholysis reaction is performed by using recycled polyethylene terephthalate (PET) with aliphatic diols to form an intermediate product, wherein the intermediate product is bis 2-hydroxyethyl terephthalate (BHET), and since a recycled PET waste material is used in step S100, the intermediate product can be regarded as recycled bis 2-hydroxyethyl terephthalate (rBHET), but the disclosure is not limited thereto. Here, the intermediate product may be an oligomer.

In some embodiments, a method of recycling polyethylene terephthalate includes, for example, collecting a recycled waste material (for example, recycled PET bottles, industrial offcuts, recycled yarns, or the like); carrying out corresponding classification according to the type, color, and/or purpose of use of the recycled waste material; then, packaging the classified recycled waste material; and transporting the packaged recycled waste material to a waste recycling plant, but the disclosure is not limited thereto, and the recycled polyethylene terephthalate can be obtained from other recycled waste materials by suitable recycling methods.

In some embodiments, the aliphatic diols are C2 to C10 aliphatic diols. For example, the aliphatic diols include ethylene glycols, 1,3-propanediols, 1,4-butanediols, or a combination thereof, but the disclosure is not limited thereto.

In some embodiments, a ratio of recycled polyethylene terephthalate to aliphatic diols in the alcoholysis reaction is 1:0.5 to 1:3 (for example, 1:0.5, 1:1, 1:1.5, 1:2, 1:2.5, 1:3, or any ratio between 1:0.5 and 1:3).

In some embodiments, a temperature used in the alcoholysis reaction is 200° C. to 250° C. (for example, 200° C., 210° C., 220° C., 230° C., 240° C., 250° C., or any temperature between 200° C. and 250° C.).

In some embodiments, a pressure used in the alcoholysis reaction is 80 kPa to 130 kPa (for example, 80 kPa, 90 kPa, 100 kPa, 110 kPa, 120 kPa, 130 kPa, or any pressure between 80 kPa and 130 kPa).

In some embodiments, a time of the alcoholysis reaction is 150 minutes to 270 minutes (for example, 150 minutes, 180 minutes, 210 minutes, 240 minutes, 270 minutes, or any time between 150 minutes and 270 minutes).

Please refer to the FIGURE. In step S200, the intermediate product is used for a polymerization reaction with long chain polyalkyl glycols (soft segment) to form a thermoplastic polyester elastomer. Accordingly, the polyester raw material used in the manufacturing method of the thermoplastic polyester elastomer according to this embodiment comes from recycled polyethylene terephthalate. The polyethylene terephthalate is recycled and used repeatedly to reduce the environmental problems caused by PET waste materials, and the use of bis 2-hydroxyethyl terephthalate (BHET) as a hard segment has higher heat resistance. In addition, since no transesterification reaction is performed after the formation of the intermediate product (bis 2-hydroxyethyl terephthalate), the by-product, THF, is not easily produced, and one manufacturing process is omitted. Thereby, energy consumption and carbon emission can be reduced, so environmental protection can be effectively achieved. In addition, since one manufacturing process is omitted, the manufacturing method is advantageous in low cost, simple manufacturing, and being industrially applicable, but the disclosure is not limited thereto.

In some embodiments, the long chain polyalkyl glycols include polyethylene glycols (PEG), polytetramethylene ether glycols, or a combination thereof, but the disclosure is not limited thereto.

In some embodiments, a ratio of the intermediate product (BHET) as a hard segment in the thermoplastic polyester elastomer is 40 wt % to 80 wt % (for example, 40 wt %, 50 wt %, 60 wt %, 70 wt %, 80 wt %, or any weight ratio between 40 wt % and 80 wt %). Here, bis(2-hydroxybutyl)terephthalate (BHBT) is not used as an intermediate product to serve as a hard segment.

In some embodiments, a ratio of the long chain polyalkyl glycols as a soft segment in the thermoplastic polyester elastomer is 20 wt % to 60 wt % (for example, 20 wt %, 30 wt %, 40 wt %, 50 wt %, 60 wt % or any weight ratio between 20 wt % and 60 wt %).

In some embodiments, a temperature used in the polymerization reaction is 230° C. to 280° C. (for example, 230° C., 240° C., 250° C., 260° C., 270° C., 280° C., or any temperature between 230° C. to 280° C.).

In some embodiments, a pressure used in the polymerization reaction is 0 kPa to 50 kPa (for example, 0 kPa, 10 kPa, 20 kPa, 30 kPa, 40 kPa, 50 kPa, or any pressure between 0 kPa and 50 kPa).

In some embodiments, a time of the polymerization reaction is 90 minutes to 270 minutes (for example, 90 minutes, 120 minutes, 150 minutes, 180 minutes, 210 minutes, 240 minutes, 270 minutes, or any time between 90 minutes and 270 minutes).

In some embodiments, an antioxidant is used in both the alcoholysis reaction and the polymerization reaction, so that the color stability can be further maintained, wherein the antioxidant does not participate in the reactions, but the disclosure is not limited thereto.

In some embodiments, the antioxidant includes pentaerythritol tetrakis(3,5-di-tert-butyl-4-hydroxy)phenylpropionate, tris(2,4-di-tert-butyl)phenyl phosphite, 3-(3,5-di-tert-butyl-4-hydroxyphenyl)propionic acid n-octadecyl ester, or a combination thereof, but the disclosure is not limited thereto.

In some embodiments, an amount of addition of the antioxidant is 100 ppm to 5000 ppm (for example, 100 ppm, 300 ppm, 500 ppm, 800 ppm, 1000 ppm, 3000 ppm, 5000 ppm, or any amount of addition between 100 ppm and 5000 ppm).

In some embodiments, an alcoholysis catalyst is used in the alcoholysis reaction, and the alcoholysis catalyst includes a titanium compound, a tin compound, an antimony compound, or a combination thereof. The titanium compound is, for example, tetrabutyl titanate, titanyl oxalate, etc. The tin compound is, for example, dibutyltin dilaurate, dioctyltin, and tin oxide. The antimony compound is, for example, antimony trioxide and antimony triacetate, but the disclosure is not limited thereto.

In some embodiments, an amount of addition of the alcoholysis catalyst is 50 ppm to 500 ppm (for example, 50 ppm, 100 ppm, 150 ppm, 200 ppm, 250 ppm, 300 ppm, 400 ppm, 500 ppm, or any amount of addition between 50 ppm and 500 ppm).

In some embodiments, a polymerization catalyst is used in the polymerization reaction, and the polymerization catalyst includes a titanium compound, a magnesium compound, a sodium compound, a phosphorus compound, a tin compound, an antimony compound, or a combination thereof. The titanium compound is, for example, tetrabutyl titanate and titanyl acetate. The magnesium compound is, for example, magnesium oxide and magnesium oxyacetate. The sodium compound is, for example, sodium oxide and sodium oxyacetate. The phosphorus compound is, for example, phosphorus oxide and phosphooxyacetate. The tin compound is, for example, dioctyltin and tin oxide. The antimony compound is, for example, antimony trioxide and antimony triacetate, but the disclosure is not limited thereto.

In some embodiments, an amount of addition of the polymerization catalyst is 50 ppm to 1000 ppm (for example, 50 ppm, 100 ppm, 300 ppm, 500 ppm, 700 ppm, 1000 ppm, or any amount of addition between 50 ppm and 1000 ppm).

In some embodiments, the thermoplastic polyester elastomer can be made into a moisture-permeable waterproof membrane by a suitable method.

In some embodiments, a thickness of the moisture-permeable waterproof membrane made of the thermoplastic polyester elastomer is 10 microns to 50 microns, a moisture permeability thereof is 10000 g/m²·24 hr to 150000 g/m²·24 hr, and a water pressure resistance thereof is greater than 15000 mm-H₂O, but the disclosure is not limited thereto.

Some examples of the manufacturing method of the thermoplastic polyester elastomer according to the disclosure are provided hereinafter; however, these examples are illustrative, and the disclosure is not limited to the examples.

### Example 1

80 kilograms of recycled polyethylene terephthalate, 120 kilograms of aliphatic diols (ethylene glycols), and 200 ppm of the alcoholysis catalyst (titanium catalyst) were used to perform the alcoholysis reaction to obtain 80 kilograms of the intermediate product (rBHET). Next, 20 kilograms of long chain polyalkyl glycols (polyethylene glycols), 500 ppm of the polymerization catalyst (titanium catalyst and magnesium catalyst), and 1000 ppm of the antioxidant were used to perform the polymerization reaction to obtain the end product, 100 kilograms of the thermoplastic polyester elastomer (TPEE). Then, the thermoplastic polyester elastomer was respectively made into moisture-permeable waterproof membranes with thicknesses of 15 microns and 40 microns for testing the physical properties.

### Example 2

The manufacturing method of the thermoplastic polyester elastomer according to Example 2 is similar to the manufacturing method of the thermoplastic polyester elastomer according to Example 1, and the difference is that the weight of the intermediate product (rBHET) used was 60 kilograms, and the weight of long chain polyalkyl glycols used was 40 kilograms.

### Example 3

The manufacturing method of the thermoplastic polyester elastomer according to Example 3 is similar to the manufacturing method of the thermoplastic polyester elastomer according to Example 1, and the difference is that the weight of the intermediate product (rBHET) used was 40 kilograms, and the weight of long chain polyalkyl glycols used was 60 kilograms.

### Comparative Example 1

Polymerization and transesterification reactions were performed by using terephthalic acid (PTA) and 1,4 butanediols (1,4BG) to obtain the intermediate product, bis(2-hydroxybutyl)terephthalate (BHBT). 80 kilograms of the intermediate product (BHBT) were used for a polymerization reaction with 20 kilograms of long chain polyalkyl glycols to obtain the end product, 100 kilograms of the thermoplastic polyester elastomer (TPEE). Then, the thermoplastic polyester elastomer was respectively made into moisture-permeable waterproof membranes with thicknesses of 15 microns and 40 microns for testing the physical properties. It should be noted that Examples 1 to 3 and Comparative Example 1 produced moisture-permeable waterproof membranes under the same conditions.

Table 1 shows the results of the physical property tests of Examples 1 to 3 and Comparative Example 1. According to Table 1, it can be known that the moisture-permeable waterproof membranes made of the thermoplastic polyester elastomer in Examples 1 to 3 have comparable or better physical properties compared with the moisture-pereable waterproof membrane made of the thermoplastic polyester elastomer in Comparative Example 1. Therefore, the examples can produce a moisture-permeable waterproof membrane with excellent performance while omitting one manufacturing process (without transesterification), reducing energy consumption and carbon emission, and effectively achieving environmental protection.

TABLE 1

| | Moisture | Water Pressure | Tensile |
|---|---|---|---|
| | Permeability | Resistance | Strength |
| | (g/m² · 24 hr) | (mm-H₂O) | (MPa) |
| Example 1 (15 microns of | >10000 | >15000 | 39 |
| membrane) | | | |
| Example 1 (40 microns of | >7000 | >15000 | 43 |
| membrane) | | | |
| Example 2 (15 microns of | >60000 | >15000 | 33 |
| membrane) | | | |
| Example 2 (40 microns of | >40000 | >15000 | 41 |
| membrane) | | | |
| Example 3 (15 microns of | >150000 | >150000 | 29 |
| membrane) | | | |
| Example 3 (40 microns of | >120000 | >150000 | 32 |
| membrane) | | | |
| Comparative Example 1 (15 | >9000 | >10000 | 33 |
| microns of membrane) | | | |
| Comparative Example 1 (40 | >5000 | >10000 | 38 |
| microns of membrane) | | | |

To sum up, the polyester raw material used in the manufacturing method of the thermoplastic polyester elastomer according to the disclosure comes from recycled polyethylene terephthalate, so that polyethylene terephthalate is recycled and used repeatedly to reduce the environmental problems caused by PET waste materials, and the use of bis 2-hydroxyethyl terephthalate (BHET) as a hard segment has higher heat resistance. In addition, since no transesterification reaction is performed after the formation of the intermediate product (bis 2-hydroxyethyl terephthalate), the by-product, THF, is not easily produced, and one manufacturing process is omitted. Thereby, energy consumption and carbon emission can be reduced, so environmental protection can be effectively achieved.

Although the disclosure has been disclosed as above with embodiments, they are not intended to limit the disclosure. People with ordinary skills in the art can make some changes and modifications without departing from the spirit of the disclosure, so the scope of the disclosure shall be defined by the following claims.

What is claimed is:

1. A manufacturing method of a thermoplastic polyester elastomer, comprising:
performing an alcoholysis reaction by using recycled polyethylene terephthalate with aliphatic diols to form an intermediate product, wherein the intermediate product is bis 2-hydroxyethyl terephthalate; and
using the intermediate product for a polymerization reaction with long chain polyalkyl glycols to form the thermoplastic polyester elastomer.

2. The manufacturing method of the thermoplastic polyester elastomer according to claim 1, wherein in the alcoholysis reaction, a ratio of the recycled polyethylene terephthalate to the aliphatic diols is 1:0.5 to 1:3.

3. The manufacturing method of the thermoplastic polyester elastomer according to claim 1, wherein a ratio of the intermediate product in the thermoplastic polyester elastomer is 40 wt % to 80 wt %.

4. The manufacturing method of the thermoplastic polyester elastomer according to claim 1, wherein a ratio of the long chain polyalkyl glycols in the thermoplastic polyester elastomer is 20 wt % to 60 wt %.

5. The manufacturing method of the thermoplastic polyester elastomer according to claim 1, wherein the aliphatic diols comprise ethylene glycols, 1,3-propanediols, 1,4-butanediols, or a combination thereof.

6. The manufacturing method of the thermoplastic polyester elastomer according to claim 1, wherein the long chain polyalkyl glycols comprise polyethylene glycols.

7. The manufacturing method of the thermoplastic polyester elastomer according to claim 1, further comprising using an antioxidant in both the alcoholysis reaction and the polymerization reaction.

8. The manufacturing method of the thermoplastic polyester elastomer according to claim 7, wherein an amount of addition of the antioxidant is 100 ppm to 5000 ppm.

9. The manufacturing method of the thermoplastic polyester elastomer according to claim 1, wherein an alcoholysis catalyst is used in the alcoholysis reaction, and the alcoholysis catalyst comprises a titanium compound, a tin compound, an antimony compound, or a combination thereof.

10. The manufacturing method of the thermoplastic polyester elastomer according to claim 1, wherein a polymerization catalyst is used in the polymerization reaction, and the polymerization catalyst comprises a titanium compound, a magnesium compound, a sodium compound, a phosphorus compound, a tin compound, an antimony compound, or a combination thereof.
